(19) United States
(12) Patent Application Publication
(10) Pub. No.: US 2009/0040497 A1
(43) Pub. Date: Feb. 12, 2009

(54) EXPOSURE APPARATUS, ADJUSTING METHOD, EXPOSURE METHOD, AND DEVICE FABRICATION METHOD

(75) Inventor: Tomoaki Kawakami, Utsunomiya-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/187,468

(22) Filed: Aug. 7, 2008

(30) Foreign Application Priority Data
Aug. 8, 2007 (JP) 2007-207183

(51) Int. Cl. G03B 27/72; G01J 1/00

(52) U.S. Cl. 355/71; 356/213

(57) ABSTRACT

The present invention provides an exposure apparatus comprising an illumination optical system configured to illuminate an original with light from a light source, a projection optical system configured to project a pattern image of the original onto a substrate, an optical integrator configured to form a pupil plane of the illumination optical system on an exit surface of the optical integrator, a first light-shielding unit and a second light-shielding unit each of which includes a plurality of light-shielding plates configured to shield certain components of the light from the light source, and a driving unit configured to drive the plurality of light-shielding plates.

### BACKGROUND OF THE INVENTION

1. Field of the Invention

The present invention relates to an exposure apparatus, an adjusting method, an exposure method, and a device fabrication method.

2. Description of the Related Art

A projection exposure apparatus which transfers a circuit pattern formed on a reticle (mask) onto, for example, a wafer has conventionally been employed to fabricate, for example, a micropatterned semiconductor device such as a semiconductor memory or logic circuit by using photolithography.

Along with the recent rapid progress in the micropatterning of semiconductor devices, the projection exposure apparatus has come to transfer a pattern with a line width as very small as 0.1 μm or less. In addition, to attain further micropatterning of semiconductor devices, a demand for improving the resolving power of the projection exposure apparatus is further increasing.

Various kinds of resolution enhanced technologies (e.g., an improvement in photoresist, and development in phase shift mask) have been proposed to allow the projection exposure apparatus to transfer a pattern with a submicron-order line width. One resolution enhanced technology is known to control the angular characteristic (to be referred to as an “effective light source or effective light source distribution” hereinafter) of light which illuminates the pattern of a reticle (which is supplied to a transfer pattern). The angular characteristic herein is equivalent to the light intensity distribution on the pupil plane of the illumination optical system.

Controlling the effective light source amounts to controlling the light intensity distribution on the pupil plane of the illumination optical system. The projection exposure apparatus forms a desired light intensity distribution on the pupil plane of the illumination optical system using, for example, an illumination shape converting unit and variable magnification relay lens. Note that a light intensity distribution formed on the pupil plane of the illumination optical system often shifts from a desired one due to, e.g., a manufacturing error, an assembly error, and differences in polarization transmittance and polarization reflectance of an optical element (differences in transmittance and reflectance of an optical element with respect to the light polarization state), and aberration included in the optical system.

Under the circumstance, Japanese Patent Laid-Open No. 2002-75843 proposes a technique of inserting a light-shielding member in the vicinity of the pupil plane of the illumination optical system, and shielding light on the pupil plane, thereby finely adjusting the light intensity distribution (effective light source). Japanese Patent Laid-Open Nos. 2002-93700 and 2007-27240 also propose techniques of inserting two two-dimensional filters with nonuniform transmittances on their surfaces onto the pupil plane of the illumination optical system, and rotating these filters, thereby obtaining a nearly desired light intensity distribution (effective light source).

However, as the micropatterning of semiconductor devices progresses, the required accuracy of controlling the light intensity distribution on the pupil plane of the illumination optical system increases. It is therefore becoming hard for the prior arts to form a light intensity distribution which meets the required accuracy. For example, these days, a tolerable shift from a desired light intensity distribution is reducing to the degree that even a very small difference (individual difference) which occurs between apparatuses of the same type cannot be tolerated. It is also desired to stably supply the same effective light source to all exposure apparatuses without any influences of a manufacturing error, an assembly error, and the polarization state of an optical element.

There are various situations in which one wants to positively give asymmetry to the effective light source (i.e., form an asymmetrical effective light source) in the projection exposure apparatus. For example, one often wants to form an effective light source in which the ratio (HV light amount ratio) between its light amounts in the horizontal (H) and vertical (V) directions is not 1:1. One often wants to form a cross-pole effective light source or the like such that the respective poles have the same shape but exhibit different light intensity distributions. One often wants to form a cross-pole effective light source, in which the angle of pole (aperture) of the pole in the V direction is larger than that in the H direction, such that the pole in the V direction has a light intensity weaker than that in the H direction to uniform the light intensity of each pole. One often wants to form an effective light source in which the ratio (HV barycenter ratio) between its barycenters (light amount barycenters) in the H and V directions is not 1:1. For example, one often wants to form a cross-pole effective light source such that the barycenter of the pole in the V direction comes close to or separates from its center relative to the pole in the H direction. In this manner, one often wants to positively change HV differences such as the HV light amount ratio and HV barycenter ratio of the effective light source rather than adjust the effective light source. In such cases, a unit capable of easily adjusting only a changing target portion on the light intensity distribution on the pupil plane of the illumination optical system is necessary.

### SUMMARY OF THE INVENTION

The present invention provides an exposure apparatus and adjusting method which can easily adjust the light intensity distribution on the pupil plane of an illumination optical system with high accuracy.

According to the first aspect of the present invention, there is provided an exposure apparatus comprising an illumination optical system configured to illuminate an original with light from a light source, a projection optical system configured to project a pattern image of the original onto a substrate, an optical integrator configured to form a pupil plane of the illumination optical system on an exit surface of the optical integrator, a first light-shielding unit and a second light-shielding unit each of which includes a plurality of light-shielding plates configured to shield certain components of the light from the light source, and a driving unit configured to drive the plurality of light-shielding plates, wherein the first light-shielding unit is inserted onto a plane which is perpendicular to an optical axis of the illumination optical system and includes a region through which both a central light beam which converges at an intersection between an incident surface of the optical integrator and the optical axis of the illumination optical system, and an outermost light beam which converges at a position farthest from the intersection on the incident surface propagate, and the second light-shielding unit is inserted onto a plane which is perpendicular to the optical axis of the illumination optical system and does not include the region through which both the central light beam and the outermost light beam propagate.

According to the second aspect of the present invention, there is provided an adjusting method of adjusting a light intensity distribution on a pupil plane of an illumination optical system which illuminates an original, comprising steps of measuring the light intensity distribution on the pupil plane of the illumination optical system, selecting, based on the light intensity distribution measured in the step of measuring, at least one of a first light-shielding unit which shields certain components of illumination light and is inserted onto a plane which is perpendicular to an optical axis of the illumination optical system and includes a region through which both a central light beam which converges at an intersection between the optical axis of the illumination optical system and an incident surface of an optical integrator which forms the pupil plane of the illumination optical system on an exit surface of the optical integrator, and an outermost light beam which converges at a position farthest from the intersection on the incident surface propagate, and a second light-shielding unit which shields certain components of the illumination light and is inserted onto a plane which is identical to the perpendicular plane and does not include the region through which both the central light beam and the outermost light beam propagate, and controlling the light-shielding unit selected in the step of selecting.

According to the third aspect of the present invention, there is provided an exposure method comprising steps of illuminating the original using the light intensity distribution adjusted by the above adjusting method, and transferring a pattern image of the original onto a substrate by exposure.

According to the fourth aspect of the present invention, there is provided a device fabrication method comprising steps of exposing a substrate using the above exposure apparatus, and performing a development process for the substrate exposed.

Further features of the present invention will become apparent from the following description of exemplary embodiments with reference to the attached drawings.

### BRIEF DESCRIPTION OF THE DRAWINGS

FIG. 1 is a schematic sectional view showing an exposure apparatus according to one aspect of the present invention.

FIGS. 2A and 2B are views illustrating annular effective light source distributions.

FIGS. 3A and 3B are views showing an example of an illumination shape converting unit which forms the annular effective light source distributions shown in FIGS. 2A and 2B.

FIG. 4 is a view showing an example of a first light-shielding unit in a light-shielding mechanism of the exposure apparatus shown in FIG. 1.

FIG. 5 is a view showing another example of the first light-shielding unit in the light-shielding mechanism of the exposure apparatus shown in FIG. 1.

FIG. 6 is an enlarged view showing the optical path from a diffractive optical element to a fly-eye lens in an illumination optical system of the exposure apparatus shown in FIG. 1.

FIGS. 7A to 7F are views illustrating examples of the light intensity distribution on the pupil plane of the illumination optical system of the exposure apparatus shown in FIG. 1.

FIGS. 8A to 8F are views for explaining the adjustment of the light intensity distribution on the pupil plane of the illumination optical system of the exposure apparatus shown in FIG. 1.

FIGS. 9A and 9B are views for explaining an example of an evaluation method of evaluating the light intensity distribution on the pupil plane of the illumination optical system of the exposure apparatus shown in FIG. 1.

FIG. 10 is a view for explaining an evaluation method of evaluating the light intensity distribution on the pupil plane of the illumination optical system of the exposure apparatus shown in FIG. 1.

FIGS. 11A to 11C are views for explaining the adjustment of the light intensity distribution on the pupil plane of the illumination optical system of the exposure apparatus shown in FIG. 1.

FIGS. 12A to 12C are views showing examples of the light intensity distribution on the pupil plane of the illumination optical system of the exposure apparatus shown in FIG. 1.

FIGS. 13A and 13B are flowcharts for explaining an effective light source adjusting method which implements the same effective light source by a first exposure apparatus and second exposure apparatus.

### DESCRIPTION OF THE EMBODIMENT

A preferred embodiment of the present invention will be described below with reference to the accompanying drawings. The same reference numerals denote the same members throughput the drawings, and a repetitive description thereof will not be given.

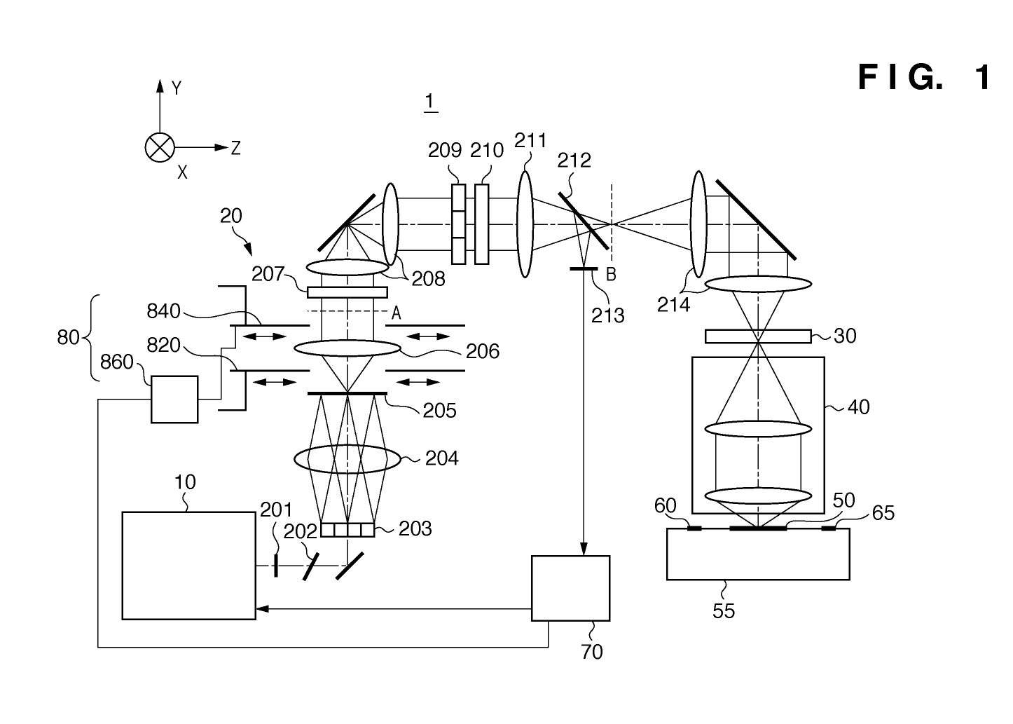

FIG. 1 is a schematic sectional view showing an exposure apparatus 1 according to one aspect of the present invention. In this embodiment, the exposure apparatus 1 is a projection exposure apparatus which transfers the pattern of a reticle (mask) 30 as an original onto a wafer 50 as a substrate by exposure using the step & scan scheme. However, the exposure apparatus 1 can adopt the step & repeat scheme or another exposure scheme.

The exposure apparatus 1 includes a light source 10, an illumination optical system 20, a projection optical system 40, a wafer stage 55 for supporting the wafer 50, an illuminance sensor 60, an effective light source measuring unit 65, a control unit 70, and a light-shielding mechanism 80.

In this embodiment, the light source 10 is an excimer laser such as a KrF excimer laser with a wavelength of about 248 nm or an ArF excimer laser with a wavelength of about 193 nm.

The illumination optical system 20 illuminates the reticle 30 with a light beam from the light source 10. In this embodiment, the illumination optical system 20 includes a λ/2 plate (½-wavelength plate) 201, neutral density filter 202, angular distribution defining element 203, condenser lens 204, diffractive optical element 205, condenser lens 206, and illumination shape converting unit 207. The illumination optical system 20 also includes a variable magnification relay lens 208, fly-eye lens 209, stop 210, condenser lens 211, beam splitter 212, exposure amount sensor 213, and relay optical system 214.

The λ/2 plate 201 is made of a birefringent glass material such as quartz crystal or magnesium fluoride, and changes the polarization state of a light beam emitted by the light source 10 into that in which the electric field vector points in a predetermined direction. The λ/2 plate 201 is retractably inserted into the optical path of the illumination optical system 20. For example, the λ/2 plate 201 is inserted into the optical path of the illumination optical system 20 in illuminating the illumination target surface with X-polarized light, while it is retracted from the optical path of the illumination optical system 20 in illuminating the illumination target surface with Y-polarized light.

The neutral density filter 202 is switchably configured to change the illuminance of illumination light in accordance with the sensitivity of a photoresist (photosensitive agent) applied on the wafer 50.

The angular distribution defining element 203 adjusts the incident light beam to emerge with a specific angular distribution so that the properties of the light beam remain the same when entering an optical system of the subsequent stage, even if the light beam from the light source 10 is decentered from the optical axis of the illumination optical system 20 due to floor vibration or apparatus vibration.

The condenser lens 204 projects the light beam from the angular distribution defining element 203 onto the incident surface of the diffractive optical element 205.

The diffractive optical element 205 generates diffracted light to form a desired light intensity distribution on the A plane via the condenser lens 206.

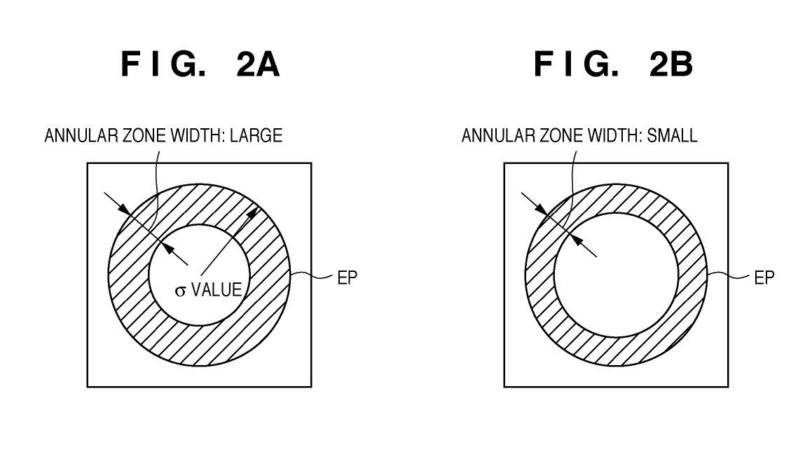

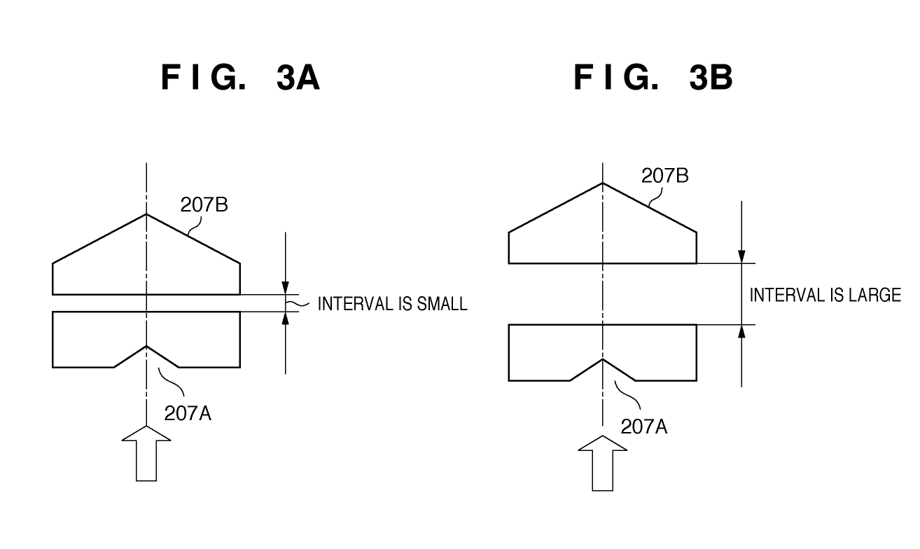

The illumination shape converting unit 207 is formed by an optical element which converts (deforms) a light beam to have an annular shape or quadrupolar shape in accordance with the illumination condition (for example, circular illumination, annular illumination, or quadrupole illumination). For example, in forming annular effective light source distributions as shown in FIGS. 2A and 2B, the illumination shape converting unit 207 is formed by a pair of prisms including a first prism 207A and second prism 207B, as shown in FIGS. 3A and 3B. Note that FIGS. 2A and 2B are views illustrating annular effective light source distributions. FIGS. 3A and 3B are views showing an example of the illumination shape converting unit 207 which forms the annular effective light source distributions shown in FIGS. 2A and 2B. The first prism 207A includes a conical concave incident surface and flat exit surface. The second prism 207B has a flat incident surface and conical convex exit surface. If the interval between the first prism 207A and the second prism 207B is small (FIG. 3A), an annular effective light source distribution in which a light-emitting portion EP has a large width (the annular zone ratio (inner σ/outer σ) is small) is formed, as shown in FIG. 2A. If the interval between the first prism 207A and the second prism 207B is large (FIG. 3B), an annular effective light source distribution in which the light-emitting portion EP has a small width (the annular zone ratio is large) is formed, as shown in FIG. 2B. For this reason, the pair of prisms including the first prism 207A and second prism 207B can improve the degree of freedom of formation of an effective light source distribution, thus forming a desired annular effective light source distribution. The pair of prisms including the first prism 207A and second prism 207B can adjust the size (σ value) of the effective light source distribution while maintaining the annular zone ratio, in cooperation with the variable magnification relay lens 208 (to be described later).

The variable magnification relay lens 208 enlarges and reduces the light beam deformed by the illumination shape converting unit 207, and projects it onto the fly-eye lens 209.

The fly-eye lens 209 serving as an optical integrator forms a plurality of light sources on its exit surface. The exit surface of the fly-eye lens 209 serves as the pupil plane of the illumination optical system 20. The fly-eye lens 209 may be, for example, a cylindrical lens, a rod lens in which rods are bundled two-dimensionally, a microlens array in which microlenses are integrated.

The condenser lens 211 superposes, via the stop 210, the light beams having undergone wavefront splitting by the fly-eye lens 209 to form a nearly uniform light intensity distribution on the B plane.

The beam splitter 212 transmits a certain component of the light beam from the condenser lens 211 to guide it to the relay optical system 214 of the subsequent stage, and reflects the remaining component of the light beam from the condenser lens 211 to guide it to the exposure amount sensor 213.

The exposure amount sensor 213 receives the light beam reflected by the beam splitter 212 to detect the exposure amount. The exposure amount sensor 213 outputs the detection result to the control unit 70.

The relay optical system 214 projects the nearly uniform light intensity distribution formed on the B plane onto the surface of the reticle 30.

The reticle 30 has a circuit pattern and is supported and driven by a reticle stage (not shown). Diffracted light generated by the reticle 30 is projected onto the wafer 50 via the projection optical system 40. Since the exposure apparatus 1 is of the step & scan scheme, it transfers the pattern of the reticle 30 onto the wafer 50 by scanning them.

The projection optical system 40 projects the pattern of the reticle 30 onto the wafer 50. The projection optical system 40 can be a dioptric system, catadioptric system, or catoptric system.

The wafer 50 is a substrate onto which the pattern of the reticle 30 is projected (transferred). However, the wafer 50 can be substituted by a glass plate or another substrate. The wafer 50 is coated with a photoresist.

The wafer stage 55 supports the wafer 50 and moves the wafer 50 in the X-, Y-, and Z-axis directions and the rotation directions about the X-, Y-, and Z-axes using, for example, a linear motor.

The illuminance sensor 60 is arranged on the wafer stage 55, and inserted into the exposure region at an arbitrary timing by the wafer stage 55, thereby measuring the illuminance in the exposure region.

The effective light source measuring unit 65 is arranged on the wafer stage 55, and includes, for example, a pinhole and two-dimensional CCD. The effective light source measuring unit 65 is inserted into the exposure region at an arbitrary timing by the wafer stage 55, and receives the light beam having passed through the pinhole by the two-dimensional CCD, thereby measuring the effective light source distribution. The effective light source measuring unit 65 and illuminance sensor 60 may be integrated as one measuring unit having both the functions.

The control unit 70 includes a CPU and memory (not shown) and controls the operation of the exposure apparatus 1. For example, the control unit 70 controls the light source 10 so that the exposure amount takes a desired value, based on the detection result obtained by the exposure amount sensor 213. In this embodiment, the control unit 70 also controls the light-shielding mechanism 80 so that the light intensity distribution on the pupil plane of the illumination optical system 20 becomes a desired one. The control unit 70 also controls operations associated with the adjustment of the light intensity distribution on the pupil plane of the illumination optical system 20.

The light-shielding mechanism 80 is inserted into the optical path between the light source 10 and the pupil plane of the illumination optical system 20 (the exit surface of the fly-eye lens 209 in this embodiment). The light-shielding mechanism 80 shields certain components of the light beam from the light source 10, thereby continuously changing the light intensity distribution on the pupil plane of the illumination optical system 20.

As shown in FIG. 1, the light-shielding mechanism 80 includes a first light-shielding unit 820, second light-shielding unit 840, and driving unit 860. Since the first light-shielding unit 820 and second light-shielding unit 840 have similar arrangements, the first light-shielding unit 820 will be explained in this embodiment.

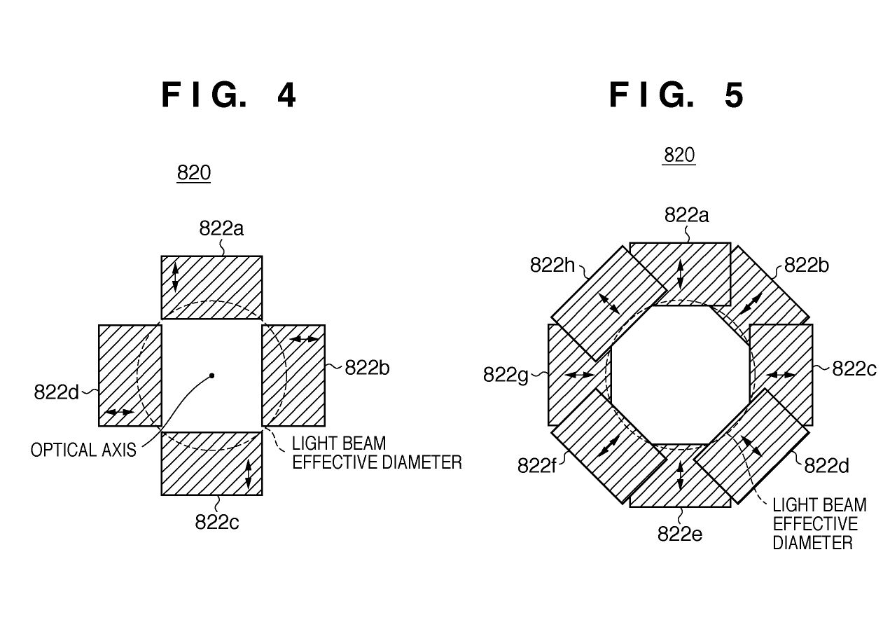

As shown in FIG. 4, the first light-shielding unit 820 is formed by a plurality of (four in this embodiment) light-shielding plates 822a to 822d which are set along a circle assuming the optical axis of the illumination optical system 20 as the center in a section, that is perpendicular to the optical axis of the illumination optical system 20, of the illumination optical system 20. The plurality of light-shielding plates 822a to 822d define the shape of the aperture of the first light-shielding unit 820. The plurality of light-shielding plates 822a to 822d are set to cover at least parts of the light beam effective diameter (i.e., a region illuminated with an exposure light beam) on the pupil plane of the illumination optical system 20, and shield certain components of the illumination light from the light source. Examples of the light-shielding plates 822a to 822d are a member made of, for example, a metal which perfectly shields light, and a neutral density filter with a desired transmittance with respect to a specific wavelength. More specifically, each of the light-shielding plates 822a to 822d is preferably a neutral density filter with a transmittance of 50% or less with respect to the wavelength of the light beam from the light source 10. The first light-shielding unit 820 is not particularly limited to the arrangement shown in FIG. 4, and may be formed by, for example, eight light-shielding plates 822a to 822h, as shown in FIG. 5. Increasing the number of light-shielding plates of the first light-shielding unit 820 makes it possible to more finely adjust the light intensity distribution on the pupil plane of the illumination optical system 20. Note that FIGS. 4 and 5 are views showing examples of the arrangement of the first light-shielding unit 820 in the light-shielding mechanism 80.

The driving unit 860 independently drives the plurality of light-shielding plates of the first light-shielding unit 820 and second light-shielding unit 840 under the control of the control unit 70. More specifically, the driving unit 860 drives the plurality of light-shielding plates of the first light-shielding unit 820 and second light-shielding unit 840 in the directions indicated by double-headed arrows shown in FIGS. 4 and 5 so that the light intensity distribution on the pupil plane of the illumination optical system 20 becomes a desired one. The driving unit 860 also has a function of driving the overall first light-shielding unit 820 and second light-shielding unit 840 (i.e., the plurality of light-shielding plates of the first light-shielding unit 820 and second light-shielding unit 840) along the optical axis of the illumination optical system 20. The driving unit 860 also has a function of rotating the overall first light-shielding unit 820 and second light-shielding unit 840 about the optical axis of the illumination optical system 20.

The insertion position of the light-shielding mechanism 80 (first light-shielding unit 820 and second light-shielding unit 840), and the function of the light-shielding mechanism 80 (first light-shielding unit 820 and second light-shielding unit 840) will be explained in detail herein.

The light-shielding mechanism 80 is preferably inserted at a position at which the first light-shielding unit 820 and second light-shielding unit 840 can be accommodated in a relatively small space, and at which the light-shielding effect can readily have an influence on the light intensity distribution on the pupil plane of the illumination optical system 20 (i.e., the light intensity distribution can be easily adjusted). In the exposure apparatus 1, the light beam diameter on the surface of the reticle 30 is greatly larger than that on the exit surface of the light source 10, so an optical element inserted closer to the upstream side of the optical system (the side of the light source 10) has a smaller light beam diameter on its surface. However, the light intensity section on the exit surface of the light source 10 is very small and has a very high energy density. Inserting the light-shielding mechanism 80 in the vicinity of the exit surface of the light source 10 severely deteriorates the light-shielding plates. In view of this, the light-shielding mechanism 80 is desirably inserted at a position at which the light beam has not too high an energy density and the beam size is small to some degree. To suppress fluctuation in light shielding by the light-shielding plates, the light-shielding mechanism 80 is desirably inserted at a position at which a change in the light intensity distribution on the pupil plane of the illumination optical system 20 is relatively insensitive to fluctuation in the light beam emitted by the light source 10.

In this embodiment, the first light-shielding unit 820 and second light-shielding unit 840 are inserted between the diffractive optical element 205 and the fly-eye lens 209, as shown in FIG. 1. This makes it possible to adjust the light intensity distribution on the pupil plane of the illumination optical system 20 without any influence of fluctuation in the light beam from the light source 10 and without increasing the sizes of the first light-shielding unit 820 and second light-shielding unit 840. To surely eliminate the influence of fluctuation in the light beam from the light source 10, an optical integrator is desirably inserted on the side of the light source 10 with respect to the angular distribution defining element 203 so that the angle, position, and size of the light beam which enters the diffractive optical element 205 always stay constant.

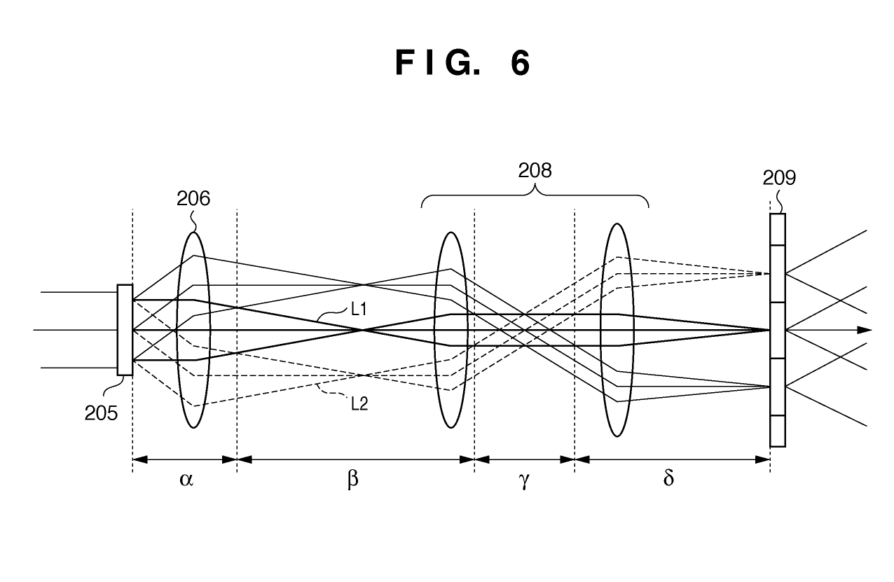

FIG. 6 is an enlarged view showing the optical path from the diffractive optical element 205 to the fly-eye lens 209 in the illumination optical system 20. Note that the illumination shape converting unit 207 is not illustrated in FIG. 6. In FIG. 6, reference symbol L1 denotes a light beam which reaches the center of the vicinity of the pupil plane of the illumination optical system 20 (the incident surface of the fly-eye lens 209). The light beam L1 is a central light beam which converges at the intersection between the incident surface of the fly-eye lens 209 and the optical axis of the illumination optical system 20. Reference symbol L2 denotes a light beam which reaches the outermost periphery of the vicinity of the pupil plane of the illumination optical system 20. The light beam L2 is an outermost light beam which converges at a position farthest from the intersection between the incident surface of the fly-eye lens 209 and the optical axis of the illumination optical system 20 on the incident surface of the fly-eye lens 209.

Referring to FIG. 6, the optical path of the illumination optical system 20 can be divided into regions in which certain components of the light beam L1 which reaches the center of the pupil plane of the illumination optical system 20 and the light beam L2 which reaches the outermost periphery of the pupil plane of the illumination optical system 20 are superposed on each other, and regions in which they are not superposed on each other. In other words, assuming that a plane perpendicular to the optical axis of the illumination optical system 20 moves along the optical axis, the optical path of the illumination optical system 20 (an on-axis position) is divided into ranges in each of which the plane includes a region through which both the light beams L1 and L2 propagate and ranges in each of which the plane does not include the region. In this embodiment, the optical path from the diffractive optical element 205 to the fly-eye lens 209 in the illumination optical system 20 can be divided into four regions (regions α, β, γ, and δ).

The four regions α to δ have different influences on the light intensity distribution on the pupil plane of the illumination optical system 20. The regions α and γ do not include the incident surface of the fly-eye lens and a plane conjugate to it, and are located farther from the incident surface and conjugate plane than the regions α and δ. Therefore, when the light-shielding mechanism 80 is inserted into the regions α and γ, the shadow of the light-shielding plate projected onto the pupil plane of the illumination optical system 20 extends over a wide range of the pupil plane of the illumination optical system 20.

The regions α and δ include the incident surface of the fly-eye lens and a plane conjugate to it, and include regions closer to the incident surface and conjugate plane than the regions α and γ. Therefore, when the light-shielding mechanism 80 is inserted into the regions α and δ, the shadow of the light-shielding plate projected onto the pupil plane of the illumination optical system 20 falls within a narrow range of the pupil plane of the illumination optical system 20.

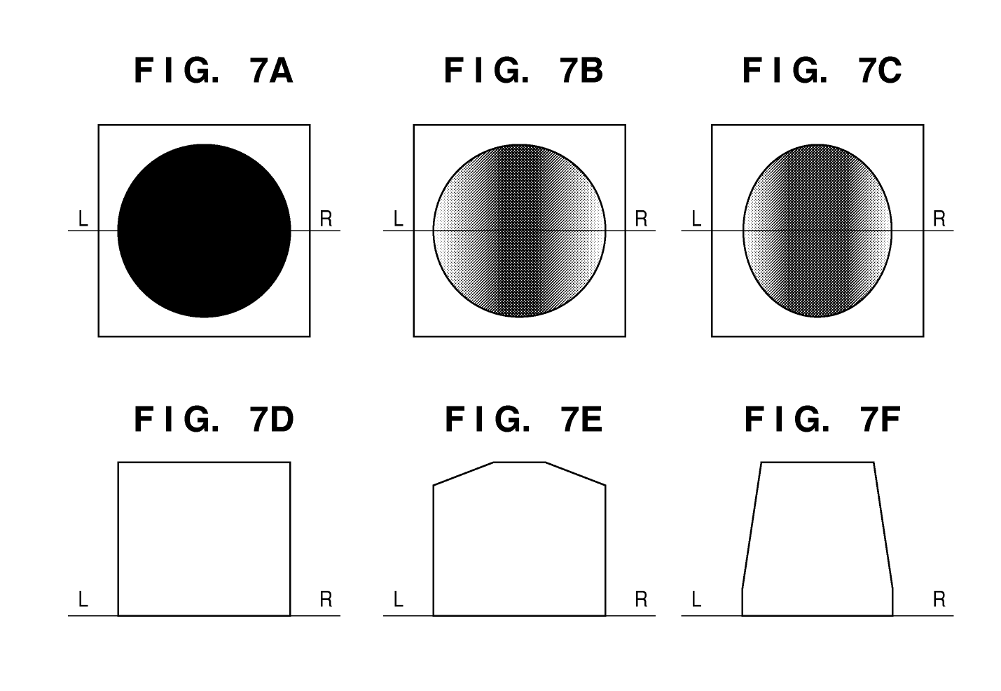

FIGS. 7A to 7F are views illustrating examples of the light intensity distribution on the pupil plane of the illumination optical system 20. FIGS. 7A, 7B, and 7C show the light intensity distributions on the pupil plane of the illumination optical system 20. FIGS. 7D, 7E, and 7F show the light intensities in sections taken along lines L-R (in the H direction) of the light intensity distributions shown in FIGS. 7A, 7B, and 7C. FIGS. 7A and 7D exemplify a case in which the light-shielding mechanism 80 does not shield the illumination light. FIGS. 7B and 7E exemplify a case in which the light-shielding plates of the first light-shielding unit 820 or second light-shielding unit 840 inserted into the region α or γ are driven only in the H direction. FIGS. 7C and 7F exemplify a case in which the light-shielding plates of the first light-shielding unit 820 or second light-shielding unit 840 inserted into the region β or δ are driven only in the H direction.

The first light-shielding unit 820 inserted into the region α or γ has a more moderate, wide-range influence on the light intensity distribution on the pupil plane of the illumination optical system 20 than the second light-shielding unit 840 inserted into the region β or δ. On the other hand, the second light-shielding unit 840 inserted into the region β or δ has a more rapid, narrow-range influence on the light intensity distribution on the pupil plane of the illumination optical system 20 than the first light-shielding unit 820 inserted into the region α or γ.

In this manner, the light-shielding mechanism 80 (first light-shielding unit 820 and second light-shielding unit 840) has different influences on the light intensity distribution on the pupil plane of the illumination optical system 20 depending on its insertion position. In view of this, first, the effective light source (the light intensity distribution on the pupil plane of the illumination optical system) measured by the effective light source measuring unit 65 is compared with a desired light intensity distribution. Next, one or both of the first light-shielding unit 820 inserted into the region α or γ and the second light-shielding unit 840 inserted into the region β or δ is selected in accordance with the difference from the desired light intensity distribution. The light-shielding plates of the selected light-shielding unit are driven so that the measured effective light source comes close to the desired light intensity distribution. This makes it possible to adjust the light intensity distribution on the pupil plane of the illumination optical system 20 with high accuracy. The insertion position of the light-shielding mechanism 80 (first light-shielding unit 820 and second light-shielding unit 840) is not particularly limited to the regions α to δ shown in FIG. 6, and may be anywhere as long as the same effect can be obtained. If the relationship between the change amount of the effective light source and the driving amount of the light-shielding plate is known in advance, the driving amount may be calculated based on the difference between the measured effective light source and the desired light intensity distribution.

When a stable light source (a superhigh pressure mercury lamp such as the i-line) is used as the light source 10, optical elements (angular distribution defining element 203 and condenser lens 204) for stabilizing the properties of the light (e.g., the angle of divergence of the light) from the light source are unnecessary. In this case, the optical path between the light source 10 and the pupil plane of the illumination optical system 20 is divided into regions in which certain components of a light beam which reaches the center of the pupil plane of the illumination optical system 20 and a light beam which reaches the outermost periphery are superposed on each other, and regions in which they are not superposed on each other. The light-shielding mechanism 80 is set for each purpose.

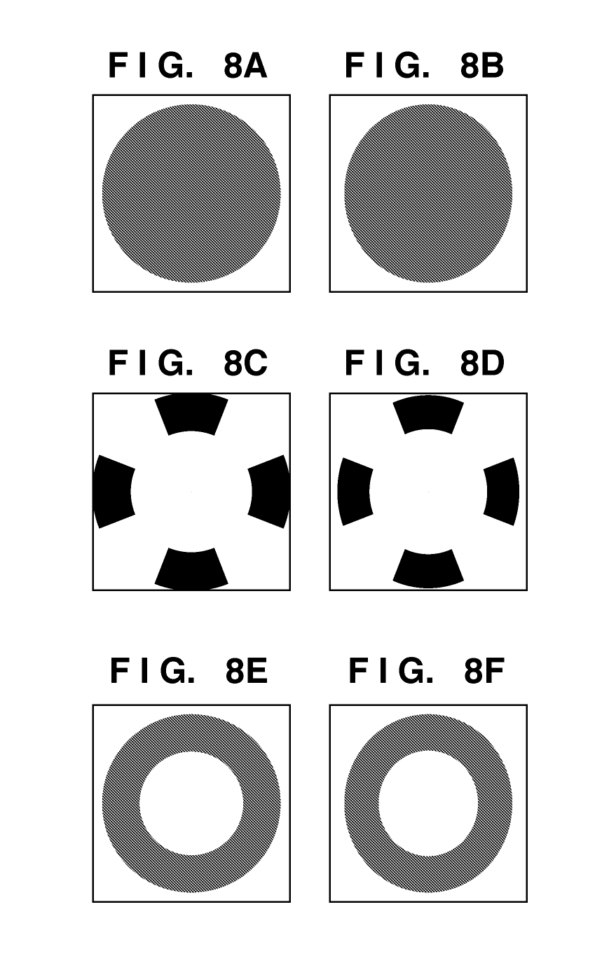

The light-shielding mechanism 80 can be used in various situations in which the light intensity distribution on the pupil plane of the illumination optical system 20 is adjusted. For example, a light intensity distribution (circular illumination) shown in FIG. 8A is formed on the pupil plane of the illumination optical system 20 under a normal condition. However, a light intensity distribution with a longer dimension in the V direction (with a shorter dimension in the H direction) as shown in FIG. 8B is often necessary due to, for example, a defect of the reticle 30. The light intensity distributions shown in FIGS. 8A and 8B differ in the shape of the light intensity distribution. The second light-shielding unit 840 which is inserted into the region β or δ and can have a strong, narrow-range influence on a change in intensity functions effectively. More specifically, light-shielding plates, which are associated with the H direction, of the second light-shielding unit 840 inserted into the region β or δ are driven. Also, a light intensity distribution (multi-pole illumination) shown in FIG. 8C and a light intensity distribution (with an annular shape) shown in FIG. 8E are formed on the pupil plane of the illumination optical system 20 in a normal state. However, light intensity distributions with longer dimensions in the V direction as shown in FIGS. 8D and 8F are often necessary. In this case, light-shielding plates, which are associated with the H direction, of the second light-shielding unit 840 inserted into the region β or δ are driven. Note that FIGS. 8A to 8F are views for explaining the adjustment of the light intensity distribution on the pupil plane of the illumination optical system 20.

In this manner, a light intensity distribution symmetrical about the optical axis can be adjusted (changed) to a light intensity distribution with a shorter dimension in the H direction (with a longer dimension in the V direction) by driving light-shielding plates, which are associated with the H direction, of the second light-shielding unit 840 inserted into the region β or δ. In other words, the second light-shielding unit 840 can adjust the shapes of regions with light amounts equal to or larger than a specific level on the pupil plane of the illumination optical system 20 while maintaining the number of them. A light intensity distribution symmetrical about the optical axis can be adjusted (changed) to a light intensity distribution with a longer dimension in the H direction by driving light-shielding plates, which are associated with the V direction, of the second light-shielding unit 840 inserted into the region β or δ.

The shape of the light intensity distribution on the pupil plane of the illumination optical system 20 is preferably adjusted using, for example, a moment as an index. The moment is a digital value representing the light intensity distribution, which is an index convenient for a relative comparison between the light intensity distributions. A moment I is defined by I=Σ((the distance of each designated coordinate position from the center of the pupil plane)×(the light intensity at each designated coordinate position))/Σ(the light intensity at each designated coordinate position).

Although a two-dimensional distribution is formed on the pupil plane of the illumination optical system 20, the moments in the H and V directions can be calculated by converting the distance of each designated coordinate position from the center of the pupil plane into the projection in the H or V direction. This makes it possible to evaluate (the moment in the H direction)/(the moment in the V direction) as an HV difference.

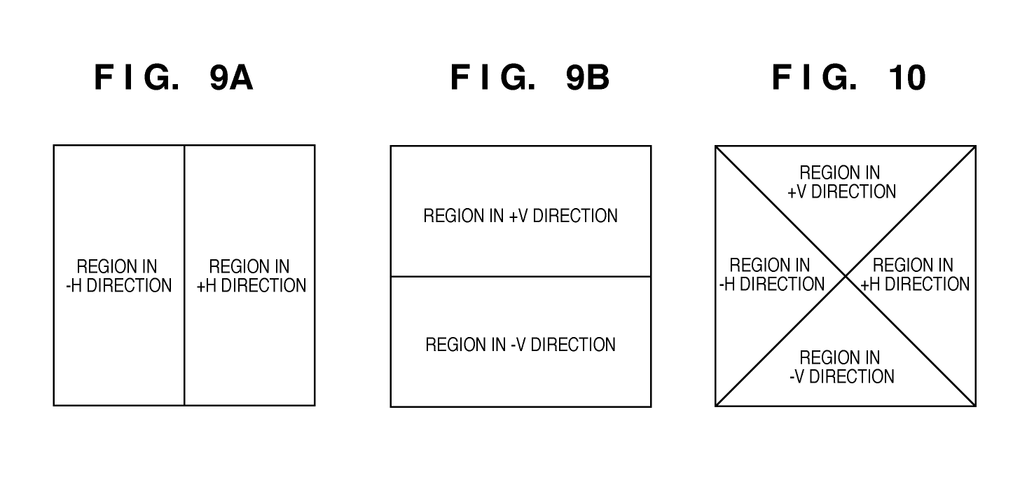

The pupil plane on the illumination optical system 20 (the light intensity distribution on it) may be divided into regions in the +V direction/−V direction (FIG. 9B) and the +H direction/−H direction (FIG. 9A) from the center of the optical axis, as shown in FIGS. 9A and 9B, thereby evaluating the light intensity distribution from the light amount barycenter of each region. This is effective especially in off-axis illumination. The pupil plane on the illumination optical system 20 (the light intensity distribution on it) may be divided into regions of (the barycentric position in the +H direction) and (the barycentric position in the −H direction), or regions of (the barycentric position in the +V direction) and (the barycentric position in the −V direction) to calculate the barycentric position of each region, thereby obtaining the average ratio of the respective absolute barycentric values. As shown in FIG. 10, the pupil plane of the illumination optical system 20 (the light intensity distribution on it) may be divided into four regions, thereby evaluating the light intensity distribution from the barycentric position of each region. These evaluation methods each desirably use an optimal evaluation index in accordance with the shape of a light intensity distribution formed on the pupil plane of the illumination optical system 20. Note that FIGS. 9A, 9B, and 10 are views for explaining examples of an evaluation method of evaluating the light intensity distribution on the pupil plane of the illumination optical system 20.

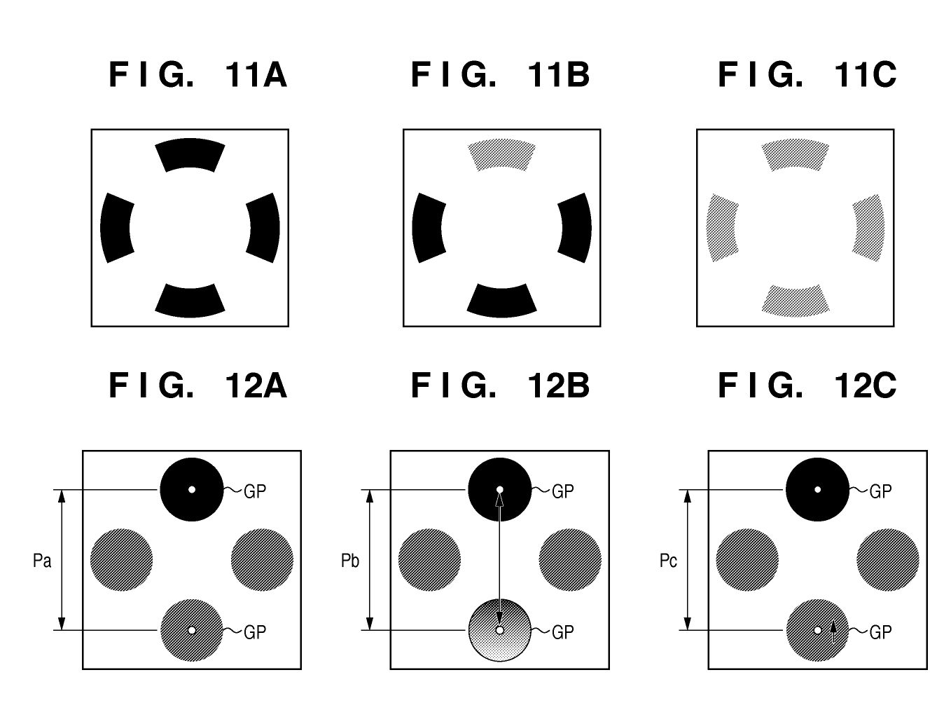

When a light intensity distribution shown in FIG. 11A is formed on the pupil plane of the illumination optical system 20 by non-polarized illumination, switching to polarized illumination often causes a variation in light intensity distribution, as shown in FIG. 11B. This is because the transmittance or reflectance of polarized light is nonuniform on the pupil plane due to the reflection characteristic of a mirror inserted into the optical path of the illumination optical system 20, the birefringence of a refractive optical element inserted into it, or the properties of, e.g., an antireflection film applied on an optical element inserted in it. In forming a light intensity distribution (FIG. 11C) with a uniform light amount (with a good light amount balance) in each region, the light intensity distribution on the pupil plane of the illumination optical system 20 is preferably adjusted (corrected) in accordance with a difference in relative light intensity which occurs on the light intensity distribution (a variation in distribution) upon polarized illumination. The variation in distribution means the light intensity ratio with respect to a maximum light intensity in the light intensity distribution on a certain plane. A variation in distribution is often asymmetrical about the optical axis upon polarized illumination. A variation in distribution occurs over a wide range of the pupil plane of the illumination optical system 20 upon polarized illumination. In this case, the first light-shielding unit 820 which is inserted into the region α or γ and can moderately adjust the light intensity distribution over a wide range functions effectively. Note that FIGS. 11A to 11C are views for explaining the adjustment of the light intensity distribution on the pupil plane of the illumination optical system 20.

A variation in light intensity distribution is desirably evaluated by, e.g., dividing the pupil plane of the illumination optical system 20 (the light intensity distribution on it) into regions in the +V direction/−V direction and the +H direction/−H direction from the center of optical axis, and performing evaluation from the barycenter of each region, as shown in FIG. 9. This is effective especially in off-axis illumination (modified illumination). The ratio among (the total light amount in the +H direction), (the total light amount in the −H direction), (the total light amount in the +V direction), and (the total light amount in the −V direction) in the respective regions may be calculated. The pupil plane of the illumination optical system 20 (the light intensity distribution on it) may be divided into four regions, as shown in FIG. 10, thereby evaluating a variation in distribution from the total light amount in each region. These evaluation methods each desirably use an optimal evaluation index in accordance with the shape of a light intensity distribution formed on the pupil plane of the illumination optical system 20.

One often wants to make the sums of the light amounts in the H and V directions nonuniform in the light intensity distribution in a normal apparatus state, depending on the pattern of the reticle 30. For example, consider a case in which the light intensities of the poles in the +V and −V directions are lower than those of the poles in the +H and −H directions in quadrupole illumination. In this case, to adjust (attenuate) only the light amount ratio in each region with a good overall balance, a first light-shielding unit 820 which is inserted into the region α or γ and can moderately adjust the light intensity distribution over a wide range is effective. The first light-shielding unit 820 can adjust the light amounts in regions with light amounts equal to or larger than a specific level on the pupil plane of the illumination optical system 20 while maintaining the number of them.

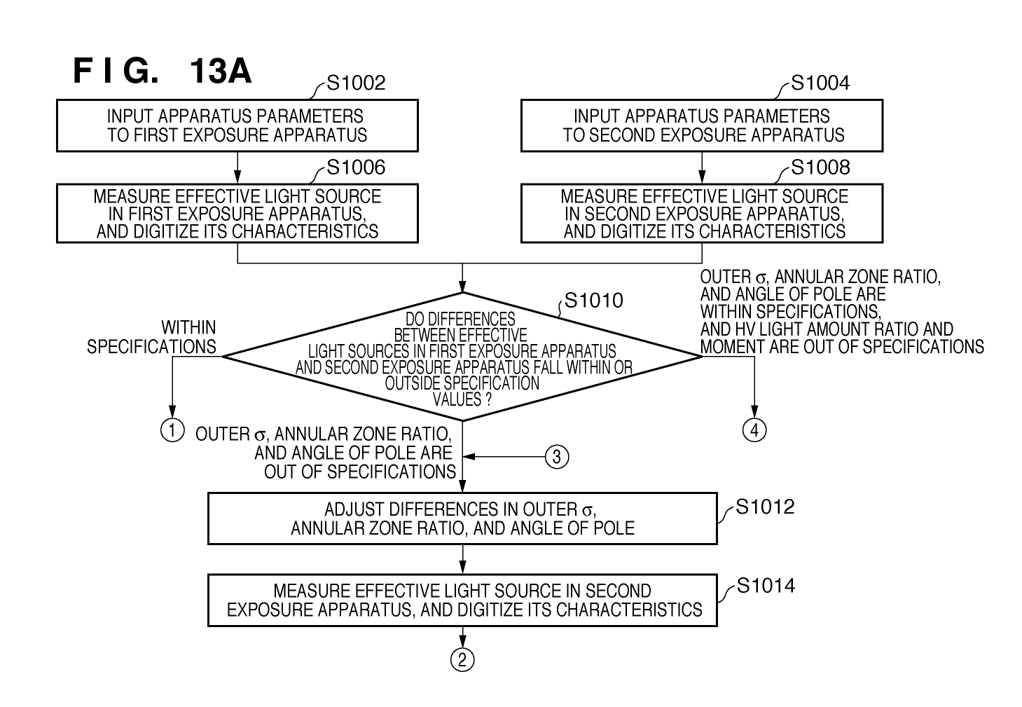

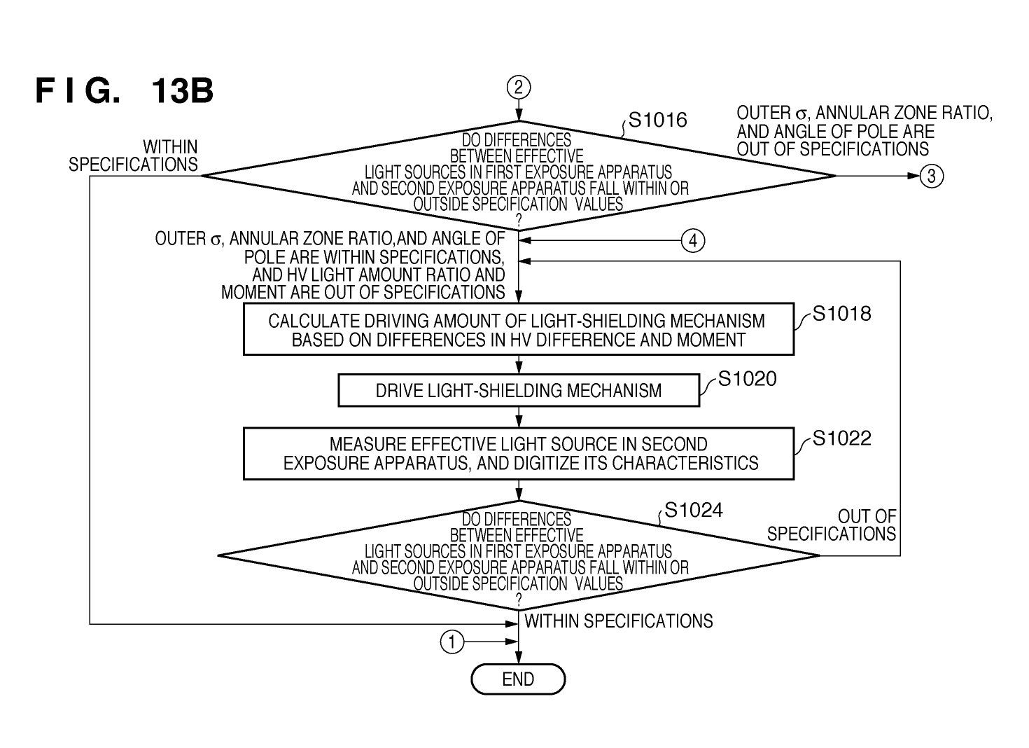

FIGS. 12A to 12C each show the influence of the use of the first light-shielding unit 820 or second light-shielding unit 840 on a quadrupolar light intensity distribution. FIG. 12A exemplifies a case in which the light-shielding mechanism 80 does not shield the illumination light. FIG. 12B exemplifies a case in which the light amount of the pole in the −V direction is attenuated using the first light-shielding unit 820 inserted into the region α or γ. FIG. 12C exemplifies a case in which the light amount of the pole in the −V direction is attenuated using the second light-shielding unit 840 inserted into the region β or δ. In FIGS. 12A to 12C, reference symbol GP indicates the barycentric position of each pole. Reference symbol Pa indicates the distance between the barycentric positions GP of the poles in the +V and −V regions when the light-shielding mechanism 80 is not used. Reference symbol Pb indicates the distance between the barycentric positions GP of the poles in the +V and −V regions when the first light-shielding unit 820 inserted into the region α or γ is used. Reference symbol Pc indicates the distance between the barycentric positions GP of the poles in the +V and −V regions when the second light-shielding unit 840 inserted into the region β or δ is used.

Referring to FIG. 12B, if the first light-shielding unit 820 inserted into the region α or γ is used, the light amount of the pole in the −V direction can be nearly uniformly attenuated almost without changing the barycentric position of each pole (Pa≈Pb). To change the light amount of each pole of the light intensity distribution (the relative light amount in each region) while maintaining the shape of the light intensity distribution, the light intensity distribution is adjusted so that an evaluation value associated with the shape of the light intensity distribution stays constant and that associated with a variation in distribution becomes a desired one.

If the second light-shielding unit 840 inserted into the region β or δ is used alone, adjusting the light intensity of each pole to a desired one decreases the dimension, in the V direction, of the light intensity distribution in the −V region, resulting in a change in Pc (Pa≠Pc) as shown in FIG. 12C. However, because it is often better to change the barycentric position of each pole depending on a process, the first light-shielding unit 820 and/or second light-shielding unit 840 is selected and controlled in accordance with the process.

In this manner, the light-shielding mechanism 80 can continuously change the HV barycenter ratio of the light intensity distribution on the pupil plane of the illumination optical system 20 by shielding certain components of the light beam from the light source 10. The light-shielding mechanism 80 also can continuously change the HV light amount ratio while maintaining the HV barycenter ratio of the light intensity distribution on the pupil plane of the illumination optical system 20. This makes it possible to adjust the light intensity distribution on the pupil plane of the illumination optical system 20 with high accuracy. The adjustment direction of the light intensity distribution on the pupil plane of the illumination optical system 20 is not particularly limited to the H and V directions, and the light amount ratio and barycenter ratio can be adjusted in an arbitrary direction.

In exposure, a light beam emitted by the light source 10 illuminates the reticle 30 by the illumination optical system 20. A light component which reflects the pattern of the reticle 30 upon being transmitted through the reticle 30 forms an image on the wafer 50 by the projection optical system 40. As described above, the exposure apparatus 1 can adjust the light intensity distribution on the pupil plane of the illumination optical system 20 by the light-shielding mechanism 80 to form a desired one with high accuracy. Hence, the exposure apparatus 1 can provide devices (e.g., a semiconductor device, an LCD device, an image sensing device (e.g., a CCD), and a thin-film magnetic head) with high throughput, high quality, and a good economical efficiency. These devices are fabricated by a step of exposing a substrate (e.g., a wafer or glass substrate) coated with a photosensitive agent using the above-described exposure apparatus 1, a step of developing the substrate (photosensitive agent), and other known steps (e.g., etching, resist removal, dicing, bonding, and packaging). According to this device fabrication method, it is possible to fabricate a device with a higher quality than in the prior arts.

The light-shielding mechanism 80 can also be used to adjust a shift in effective light source between exposure apparatuses due to their individual differences. For example, assume that an effective light source (the light intensity distribution on the pupil plane of the illumination optical system 20) implemented by a first exposure apparatus is implemented by a second exposure apparatus. In this case, a slight difference occurs between the effective light sources implemented by the first exposure apparatus and second exposure apparatus due to, e.g., a manufacturing error and adjustment error. However, the use of the light-shielding mechanism 80 allows the second exposure apparatus to faithfully implement an effective light source implemented by the first exposure apparatus.

FIGS. 13A and 13B are flowcharts for explaining an effective light source adjusting method which implements the same effective light source by the first exposure apparatus and second exposure apparatus. This embodiment will exemplify a case in which quadrupolar effective light sources are formed in the first exposure apparatus and second exposure apparatus.

In step S1002, apparatus parameters associated with the formation of an effective light source are input to the first exposure apparatus. In step S1004, the same parameters as those input to the first exposure apparatus are input to the second exposure apparatus. When effective light sources corresponding to the apparatus parameters input in steps S1002 and S1004 are formed, the effective light sources in the first exposure apparatus and second exposure apparatus are measured, and their characteristics are digitized, in steps S1006 and S1008. In this embodiment, the outer σ, the annular zone ratio, the angle of pole, the light amount ratio, the HV light amount ratio, and the moment are calculated as digital values representing the characteristics of each effective light source.

In step S1010, the differences between the effective light sources in the first exposure apparatus and second exposure apparatus measured in steps S1006 and S1008, respectively, are calculated and compared with specification values. In this embodiment, if differences in the outer σ, the annular zone ratio, and the angle of pole fall outside the specification values (out of the specifications), the process advances to step S1012. If the differences in the outer σ, the annular zone ratio, and the angle of pole fall within the specification values (within the specifications), and differences in the HV light amount ratio and moment are out of the specifications, the process advances to step S1018. If the differences in the outer σ, the annular zone ratio, the angle of pole, the HV light amount ratio, and the moment are within the specifications, the process ends without adjusting the effective light sources in the first exposure apparatus and second exposure apparatus.

In step S1012, the outer σ, the annular zone ratio, and the angle of pole are adjusted in the second exposure apparatus. More specifically, the differences in the outer σ, the annular zone ratio, and the angle of pole are adjusted to be within the specifications by, e.g., driving the illumination shape converting unit 207 or variable magnification relay lens 208 or changing the diffractive optical element 205 or stop 210 in the exposure apparatus 1 shown in FIG. 1. In step S1014, the effective light source in the second exposure apparatus is measured, and its characteristics are digitized.

In step S1016, the differences between the effective light sources in the first exposure apparatus and second exposure apparatuses measured in steps S1006 and S1014, respectively, are calculated and compared with the specification values. In this embodiment, if differences in the outer σ, the annular zone ratio, and the angle of pole are within the specifications, and differences in the HV light amount ratio and moment are out of the specifications, the process advances to step S1018. If the differences in the outer σ, the annular zone ratio, the angle of pole, the HV light amount ratio, and the moment are within the specifications, the adjustment of the effective light source is ended. If the differences in the outer σ, the annular zone ratio, and the angle of pole are out of the specifications, the process returns to step S1012.

In step S1018, based on the comparison result (the differences in HV light amount ratio and moment) obtained in step S1016, the driving amount of the light-shielding mechanism 80 is calculated in the second exposure apparatus. More specifically, whether to use the first light-shielding unit 820 or second light-shielding unit 840 is selected. The driving amounts of the plurality of light-shielding plates of the selected light-shielding unit are calculated. However, both the first light-shielding unit 820 and second light-shielding unit 840 may be used. In this case, it is necessary to calculate the driving amounts of the plurality of light-shielding plates of the first light-shielding unit 820 and second light-shielding unit 840.

In step S1020, the light-shielding mechanism 80 is driven in accordance with the driving amount calculated in step S1018. In step S1022, the effective light source in the second exposure apparatus is measured, and its characteristics are digitized. The light-shielding mechanism of one of the first exposure apparatus or second exposure apparatus may undergo the driving control, or the light-shielding mechanisms of both the exposure apparatuses may be controlled.

In step S1024, the differences between the effective light sources in the first exposure apparatus and second exposure apparatus measured in steps S1006 and S1022, respectively, are calculated and compared with the specification values. In this embodiment, if differences in HV light amount ratio and moment are out of the specifications, the process returns to step S1018. If the differences in HV light amount ratio and moment are within the specifications, the adjustment of the effective light source is ended.

In this manner, it is possible to adjust a shift in effective light source between exposure apparatuses due to their individual differences using the light-shielding mechanism 80. This allows the second exposure apparatus to faithfully implement an effective light source implemented by the first exposure apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-207183 filed on Aug. 8, 2007, which is hereby incorporated by reference herein in its entirety.

What is claimed is:

1. An exposure apparatus comprising:
an illumination optical system configured to illuminate an original with light from a light source;
a projection optical system configured to project a pattern image of the original onto a substrate;
an optical integrator configured to form a pupil plane of said illumination optical system on an exit surface of said optical integrator;
a first light-shielding unit and a second light-shielding unit each of which includes a plurality of light-shielding plates configured to shield certain components of the light from the light source; and
a driving unit configured to drive said plurality of light-shielding plates,
wherein said first light-shielding unit is inserted onto a plane which is perpendicular to an optical axis of said illumination optical system and includes a region through which both a central light beam which converges at an intersection between an incident surface of said optical integrator and the optical axis of said illumination optical system, and an outermost light beam which converges at a position farthest from the intersection on the incident surface propagate, and
said second light-shielding unit is inserted onto a plane which is perpendicular to the optical axis of said illumination optical system and does not include the region through which both the central light beam and the outermost light beam propagate.

2. The apparatus according to claim 1, wherein said light-shielding plate includes a neutral density filter.

3. An adjusting method of adjusting a light intensity distribution on a pupil plane of an illumination optical system which illuminates an original, comprising steps of:
measuring the light intensity distribution on the pupil plane of the illumination optical system;
selecting, based on the light intensity distribution measured in the step of measuring, at least one of a first light-shielding unit which shields certain components of illumination light and is inserted onto a plane which is perpendicular to an optical axis of the illumination optical system and includes a region through which both a central light beam which converges at an intersection between the optical axis of the illumination optical system and an incident surface of an optical integrator which forms the pupil plane of the illumination optical system on an exit surface of the optical integrator, and an outermost light beam which converges at a position farthest from the intersection on the incident surface propagate, and a second light-shielding unit which shields certain components of the illumination light and is inserted onto a plane which is identical to the perpendicular plane and does not include the region through which both the central light beam and the outermost light beam propagate; and
controlling the light-shielding unit selected in the step of selecting.

4. The method according to claim 3, wherein
in the step of measuring, the light intensity distribution is measured in each of a first exposure apparatus including the illumination optical system, and a second exposure apparatus including an illumination optical system different from the illumination optical system, and
in the step of selecting, at least one of the first light-shielding unit and the second light-shielding unit of one of the first exposure apparatus and the second exposure apparatus is selected based on a difference between the light intensity distribution measured in the first exposure apparatus and the light intensity distribution measured in the second exposure apparatus.

5. The method according to claim 3, wherein in the step of controlling, a plurality of light-shielding plates which form the first light-shielding unit are driven.

6. The method according to claim 3, wherein in the step of controlling, a plurality of light-shielding plates which form the second light-shielding unit are driven.

7. An exposure method comprising steps of:
illuminating the original using the light intensity distribution adjusted by an adjusting method according to claim 3; and
transferring a pattern image of the original onto a substrate by exposure.

8. A device fabrication method comprising steps of:
exposing a substrate using an exposure apparatus according to claim 1; and
performing a development process for the substrate exposed.
